(19) United States
(12) Patent Application Publication
(10) Pub. No.: US 2010/0084234 A1
(43) Pub. Date: Apr. 8, 2010

(54) DUAL CONSTRAINT DISC VALVE SYSTEM FOR DAMPER

(76) Inventor: Robert Patrick Marble, White Lake, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/246,561

(22) Filed: Oct. 7, 2008

(51) Int. Cl. F16F 13/26; F16F 13/06

(52) U.S. Cl. 188/280; 188/322.15

(57) ABSTRACT

A valve assembly for a damper includes a piston with a central hole to receive a rod and at least one fluid passage spaced form the central hole. At least one deflecting disc is positioned on one side of the piston to at least partially overlap the fluid passage. The deflecting disc includes a center opening that is aligned with the central hole of the piston and is defined by an inner peripheral surface at the center opening. At least one translating disc is positioned in an overlapping relationship with the deflecting disc and is defined by an outer peripheral surface. A cage is positioned over the deflecting and translating discs and includes an abutment feature that constrains the translating disc at the outer peripheral surface while the inner peripheral surface of the deflecting disc is constrained at the rod.

### TECHNICAL FIELD

The subject invention relates to dampers such as shock absorbers and struts for example, and more particularly to a damper with a dual constraint disc valve to provide a digressive damping force.

### BACKGROUND OF THE INVENTION

Dampers, such as shock absorbers and struts for example, are used to dissipate energy from road load inputs, providing a desired vehicle ride and handling characteristic. A typical damper includes a piston that moves axially through a cylinder that contains hydraulic fluid and valves, and which often contains a plurality of discs positioned on one or both sides of the piston. The piston includes a center opening to receive a rod and the discs include disc openings that are aligned with the center opening. The piston also includes fluid passages that are spaced from the center opening. The discs are positioned to at least partially overlap the fluid passages.

Fluid flows through the fluid passages as the rod moves the piston back and forth within the cylinder. This movement dissipates the energy, i.e. the road load inputs, to provide a more comfortable ride and appropriate handling. The discs, which at least partially block the fluid passages regulate fluid flow rate through the passages during compression and rebound strokes experienced by the damper.

Traditionally, the piston and discs are secured together by the rod and a nut. The nut is tightened against the discs and pistons to provide a desired preload for the disc stack. If the preload is not properly set, or if this load degrades during vehicle operation, the damping characteristics of the damper can be adversely affected. Further, it is difficult to provide a properly preloaded damper that will generate a desired digressive damping force characteristic.

Traditional solutions have modified the piston to provide a more complex piston architecture that is used in combination with other components to achieve a desired preload and damping characteristic combination. These additional components have included sintered or machined rings between pistons, tapered piston ports, coil springs, Belleville washers, multi-finger discs, etc. These solutions are expensive and do not always operate effectively as fluid flow control can be inconsistent.

### SUMMARY OF THE INVENTION

A valve assembly for a damper includes a piston with a central hole to receive a rod and at least one fluid passage spaced form the central hole. At least one deflecting disc is positioned on one side of the piston to at least partially overlap the fluid passage. The deflecting disc includes a center opening that is aligned with the central hole of the piston and is defined by an inner peripheral surface. At least one translating disc is positioned in an overlapping relationship with the at least one deflecting disc and is defined by an outer peripheral surface. A cage is positioned over the deflecting and translating discs and includes an abutment feature that constrains the translating disc at the outer peripheral surface while the deflecting is constrained at the rod disc by the inner peripheral surface.

In one example, the cage comprises a single piece structure. In one example, the cage includes a base portion with a center aperture that is aligned with the central hole of the piston and a wall portion that transitions from the base portion and extends toward the piston to form the abutment feature.

In one example, the inner peripheral surface of the deflecting disc abuts directly against the rod and the outer peripheral surface of the translating disc abuts directly against the abutment feature of the cage to provide radial constraint.

In one example, a backing washer is positioned axially between the cage and the piston. The backing washer acts to control a maximum deflection of the at least one deflecting disc.

These and other features of the present invention can be best understood from the following specification and drawings, the following of which is a brief description.

### BRIEF DESCRIPTION OF THE DRAWINGS

FIG. 1 is a schematic representation of twin tube shock absorber.

FIG. 2 is a cross-sectional perspective view of a piston valve assembly with a cage.

FIG. 3 is an exploded view of the piston valve assembly and cage of FIG. 2.

### DETAILED DESCRIPTION OF THE PREFERRED EMBODIMENT

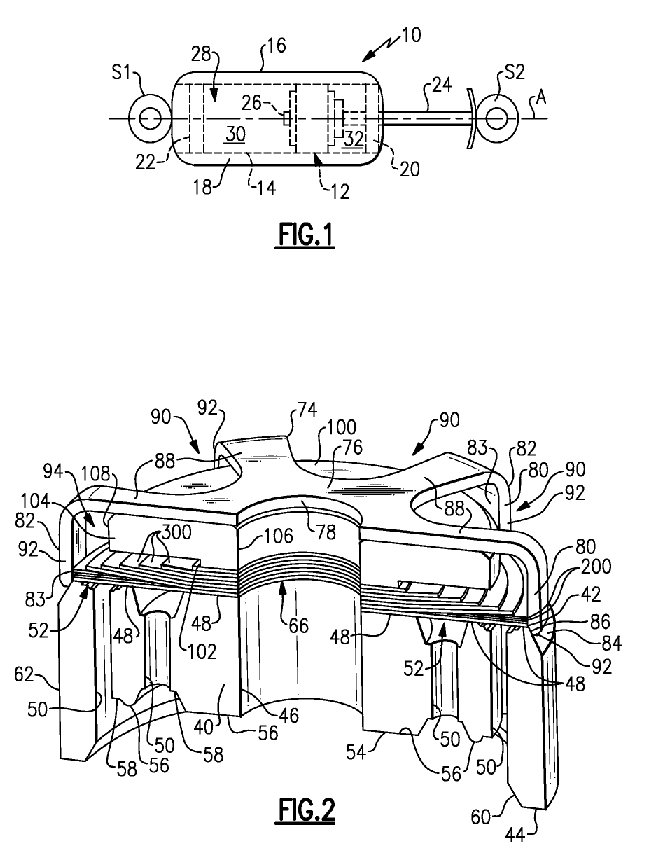

FIG. 1 is a schematic representation of a twin tube shock absorber 10 that includes the subject valve assembly 12. The twin tube shock absorber 10 is merely shown as one example of a damper, it should be understood that valve assembly 12 could also be used in other types of dampers such as a monotube or strut, for example. Further, the valve assembly could also be used in combination with a secondary valve within a shock absorber or strut.

The shock absorber 10 includes an inner cylinder 14 and an outer cylinder 16 separated by an outer chamber 18. A cylinder head 20 is mounted within the inner cylinder 14 at one end and a base valve 22 is mounted within the inner cylinder 14 at an opposite end. The valve assembly 12 is positioned within the inner cylinder 14 between the cylinder head 20 and the base valve 22. A rod 24 is secured to the valve assembly 12 with a nut 26, for example. Other attachment structures such as rivets or welding could also be used to secure the rod 24 to the valve assembly 12.

A first mounting structure S1 is associated with the outer cylinder 16 and a second mounting structure S2 is associated with the rod 24. One of the first S1 and second S2 mounting structures is coupled to a vehicle structure, such as a frame for example. The other of the first S1 and second S2 mounting structures is coupled to a component that receives road load inputs, such as a wheel or track for example.

The inner cylinder 14 defines an inner chamber 28 that is separated into a compression side 30 and a rebound side 32 by the valve assembly 12. During a compression stroke, the valve assembly 12 moves towards the base valve 22 to regulate fluid flow from the inner chamber 28 to the outer chamber 18 as known. During compression and rebound strokes, fluid flows through the valve assembly 12 between the compression 30 and rebound 32 sides of the inner chamber 28.

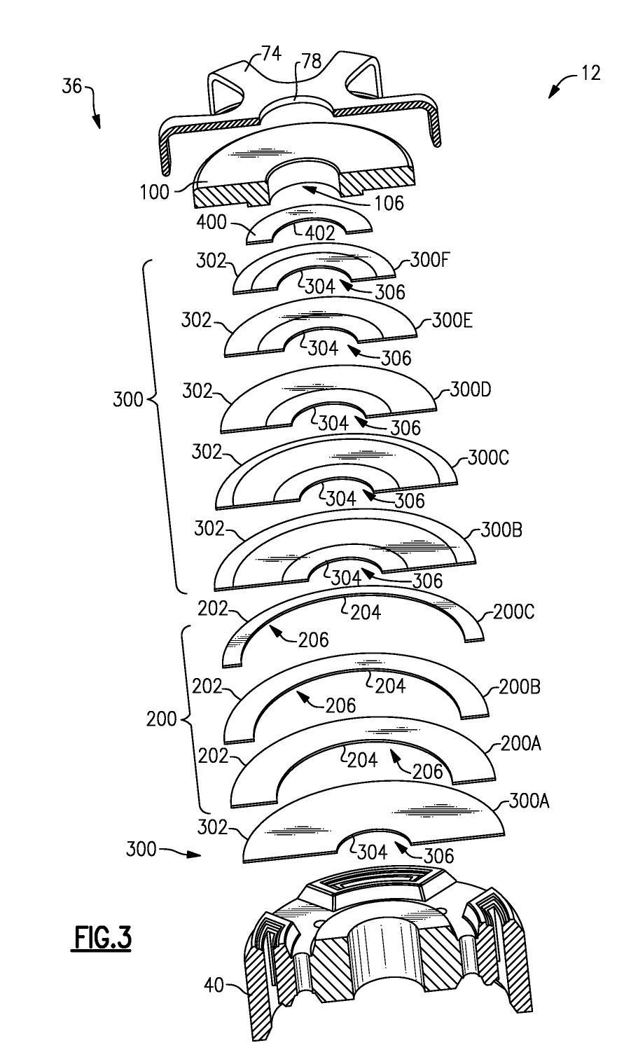

The valve assembly 12 is shown in greater detail in FIG. 2. The valve assembly 12 includes a piston 40 having a first side 42 and a second side 44 facing opposite the first side 42. The piston 40 includes a central hole 46 that extends entirely through the piston 40 from the first side 42 to the second side 44. The rod 24 extends through the central hole 46 and is coupled to the piston 40 as described above to move the valve assembly 12 axially back and forth along a center axis A (FIG. 1).

The piston 40 comprises a single plane castled piston configuration with the first side 42 providing a generally flat single plane surface that is defined by a plurality of land areas 48. A plurality of fluid passages 50 are also formed in the piston 40 which extend from the first side 42 to the second side 44. The fluid passages 50 are axial passages that are spaced radially outwardly apart from the central hole 46. Any number of fluid passages can be formed depending upon the vehicle application and desired flow rate. Axial ports 52 are formed in the first side 42 at locations of the fluid passages 50. The axial ports 52 are located on the land areas 48 in castle sections.

The second side 44 has an inner portion 54 that forms a generally flat planar surface, and consists of a plurality of land areas 56. Circular grooves 58 are formed in the second side 44 and are aligned with the fluid passages 50.

The second side 44 also includes an outer portion 60 that extends outwardly away from the inner portion 54 about an outer periphery of the inner portion 54. The outer portion 60 defines an outer peripheral surface 62 that is slidingly received within the inner cylinder 14. This outer portion 60 extends up to the first side 42 and transitions into one of the land areas 48 of the first side. This configuration forms a cup-shaped recess at the second side 44 of the piston with the first side 42 having an uppermost surface that is defined by a single plane.

A plurality of discs 66 are positioned on the first side 42 of the piston 40. It should be understood that discs 66 could also be used on both sides of the piston 40, or could be located only on the second side 44. As shown in FIG. 3, the plurality of discs 66 includes at least two different types of discs. One type of disc comprises a translating disc 200 and the other type of disc comprises a deflecting disc 300. The translating discs 200 are radially constrained at an outer periphery and the deflecting discs 300 are radially constrained at an inner peripheral surface. This will be discussed in greater detail below.

As shown in FIG. 3, the translating discs 200 are defined by an outermost peripheral surface 202 and an innermost peripheral surface 204. The innermost peripheral surface 204 defines a central opening 206 that overlaps the central hole 46 of the piston 40. The translating discs 200 provide an axial offset from the piston 40 to the deflected discs 300. The innermost peripheral surface 204 is sized such that the translating discs 200 are not constrained by the rod 24, i.e. the translating discs 200 are not clamped.

The deflecting discs 300 are defined by an outermost peripheral surface 302 and an innermost peripheral surface 304. The innermost peripheral surface 304 defines a central opening 306 that overlaps the central hole 46 of the piston 40. The deflecting discs 300 have a sufficient diameter to at least partially overlap the fluid passage 50. The deflecting discs 300 are clamped to the piston 40 at the center, and are constrained at the innermost peripheral surface 304 by the rod 24. This aligns the deflecting discs 300 radially with the rod 24.

In the example shown in FIGS. 2-3, the translating discs 200 are positioned axially closer to the piston 40 than the majority of the deflecting discs 300. Optionally, one or more deflecting discs 300 could be positioned between the piston 40 and the first translating disc 200. A pivot disc 400 is positioned on top of the plurality of deflecting discs 300. The pivot disc 400 has an innermost peripheral surface 402 that is constrained by the rod 24. All of the deflecting discs 300 pivot about this pivot disc 400. At least one deflecting disc 300 should be positioned between the pivot disc 400 and the translating disc 200; however, in the example shown, multiple deflection discs 300 are positioned between the pivot disc 400 and the translating discs 200. Further, it should be understood that while a plurality of translating discs 200 are shown in the example of FIGS. 2-3, only a single translating disc 200 may be required depending upon the application.

In the example shown, the translating discs 200 have central openings 206 that are defined by varying inner diameters with the outermost peripheral surfaces 202 being defined by a constant/common outer diameter. It should be understood that while the example discloses translating discs with varying inner diameters, the inner diameters could also be sized to have a common inner diameter. The deflecting discs 300 have a constant/common diameter defined by the innermost peripheral surface 304 at the center opening 306 and have varying outer diameters at the outermost peripheral surfaces 302. It should be understood that while varying outer diameters are shown for the deflecting discs 300, the outer diameters could be the same or different from each other.

In the example shown in FIGS. 2-3, discs 66 are stacked outwardly from the piston 40 in order of decreasing diameter with discs 66 having the largest outermost diameters being positioned nearest the first side 42 of the piston 40 and with the discs 66 having the smallest outermost diameters being positioned furthest away from the first side 42 of the piston 40. Other stacking configurations could also be used. Further, as discussed above, discs could also be positioned on the second side of the piston, or could be positioned on both sides of the piston.

In the example shown, a deflecting disc 300a is having with the largest outer diameter is positioned immediately adjacent the first side 42 of the piston. The translating discs 200 are then stacked on top of this deflecting disc 300a in an order of increasing inner diameter at the innermost peripheral surface 204. Thus, a translating disc 200a with the smallest inner diameter is positioned closest to the piston 40, the next translating disc 200b with a larger inner diameter is positioned next to translating disc 200a, and a translating disc 200c with the largest inner diameter is positioned furthest from the piston 40.

Next, the deflecting discs 300b-f are positioned on top of translating disc 200c in order of decreasing outer diameter. The deflecting disc 300b with the largest outer diameter is placed on top of translating disc 200c and the deflecting disc 300f with the smallest outer diameter is furthest away from the piston 40. The translating discs 200 are located between the deflecting discs 300 and the piston 40 to provide a preload on the deflecting discs 300 of the shock absorber 10.

A cage 74 is positioned in an overlapping relationship with the translating 200 and deflecting 300 discs. The cage 74, in one example, is formed from a single piece stamped metal structure. The cage could also be cold formed, sintered, etc., and could be made from other suitable materials.

The cage 74 includes a base portion 76 with a center aperture 78 that is aligned with the central hole 46 of the piston 40 and the central openings 206, 306 of the translating 200 and deflecting 300 discs. The center aperture 78 defines a surface that abuts directly against the rod 24. The base portion 76 transitions into a wall portion 80 that extends toward the first side 42 of the piston 40. The wall portion 80 has an outer peripheral surface 82 and an inner peripheral surface 83 that forms an abutment feature. As shown, the abutment feature radially constrains the outermost peripheral surfaces 204 of the translating discs 200. The innermost peripheral surfaces 304 of all of the deflecting discs 300 are radially constrained by direct abutment against the rod 24. The cage 74 is constrained by the rod 24 at the center aperture 78. Thus, a dual constraint disc configuration is provided by cooperation of the cage 74 and rod 24.

The outer peripheral surface 82 of the cage 74 is spaced radially inward relative to the outer peripheral surface 62 of the piston 40. As such, the outer peripheral surface 82 of the cage does not contact the inner cylinder 14. A transition surface 84 extends from the outer peripheral surface 62 of the piston 40 to a land area 48 on the first side 42 of the piston 40. The transition surface 84 is tapered and the distal end of the wall portion 80 of the cage 74 includes a corresponding tapered surface 86 that rests on the transition surface 84.

In the example shown in FIG. 2, the base portion 76 includes a center disc-shaped portion including the center aperture 78 and a plurality of radially extending extension surfaces 88 that are circumferentially spaced apart from each other about the center aperture 78 by gaps 90. The wall portion 80 comprises a plurality of fingers 92 that are spaced apart from each other by gaps 94. Each finger 92 defines a portion of the outer peripheral surface 82 of the cage 74 that faces an inner surface of the inner cylinder 14. Each finger 92 also defines a portion of the inner peripheral surface 83 that forms the abutment feature. Each extension surface 88 transitions into one corresponding finger 92.

It should be understood that while a multi-fingered configuration is shown in the example of FIGS. 2-3, the cage could also have a contiguous surface with ports.

A backing washer 100 is positioned axially between the cage 74 and the first side 42 of the piston 40. In the example shown, the backing washer 100 is placed on the disc stack such that the backing washer 100 is sandwiched between the base portion 76 of the cage 74 and the disc stack. The cage 74 and backing washer 100 cooperate to preload the discs 66 against the piston 40. Further, the backing washer 100 acts to control the maximum deflection of the deflecting discs 300.

In the example shown, the backing washer 100 includes a boss portion 102 that abuts against the disc stack and an enlarged portion 104 that abuts against the cage 74. The backing washer 100 includes a center opening 106, aligned with the central hole 46 of the piston 40 and through which the rod 24 extends. An outermost peripheral surface 108 of the backing washer 100 is spaced radially inward of the wall portion 80 of the cage 74. It should be understood that the configuration of the backing washer 100 in FIG. 2 is just one example, and that the size and shape of the backing washer 100 could be varied as needed to adjust fluid flow rates. The subject valve assembly 12 provides a configuration where the deflecting discs 300 are constrained at their inner diameter by the rod 24 and wherein the translating discs are constrained on their outer diameter by the cage 74 to provide a preload to the deflecting discs 300. The combined disc stack and cage 74 achieves a digressive characteristic fluid flow in a more consistent and controlled manner than prior configurations.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A valve assembly for a damper comprising:
a piston having a central hole to receive a rod and at least one fluid passageway spaced apart from said central hole;
at least one deflecting disc having a first center opening aligned with said central hole and positioned on one side of said piston to at least partially overlap said at least one fluid passageway, wherein said at least one deflecting disc has a first outer peripheral surface and a first inner peripheral surface comprising a rod contact surface;
at least one translating disc having a second center opening aligned with said central hole and positioned in an overlapping relationship with said at least one deflecting disc, said at least one translating disc having a second inner peripheral surface formed about said second center opening and a second outer peripheral surface; and
a cage having an abutment feature that constrains said at least one translating disc at said second outer peripheral surface.

2. The valve assembly according to claim 1 wherein said at least one deflecting disc is constrained at said first inner peripheral surface by the rod such that said at least one deflecting disc directly abuts the rod at said first inner peripheral surface and wherein said at least one translating discs directly abuts said abutment feature of said cage at said second outer peripheral surface.

3. The valve assembly according to claim 1 wherein said cage includes a base portion with a center aperture aligned with said central hole of said piston and said first and second center openings of said at least one deflecting disc and said at least one translating disc, and wherein said cage includes a wall portion that transitions from said base portion and extends toward said piston to form said abutment feature.

4. The valve assembly according to claim 3 wherein said wall portion includes gaps and provides an outer surface to face a cylinder and an inner surface that forms said abutment feature.

5. The valve assembly according to claim 4 wherein said base portion comprises a center disc-shaped portion including said center aperture and a plurality of radially extending extension surfaces that are circumferentially spaced apart from each other about said center aperture by gaps with each radially extending extension surface transitioning into said wall portion

6. The valve assembly according to claim 3 including a backing washer positioned axially between said cage and said one side of said piston.

7. The valve assembly according to claim 6 wherein said backing washer provides a positive stop for the at least one deflecting disc.

8. The valve assembly according to claim 1 wherein said at least one translating disc comprises a plurality of translating discs that are sandwiched between said one side of said piston and said at least one deflecting disc to achieve a desired preload.

9. The valve assembly according to claim 8 wherein said at least one deflecting disc comprises a plurality of deflecting discs and including a pivot disc positioned axially between said plurality of deflecting discs and said cage.

10. The valve assembly according to claim 1 wherein said cage comprises a single piece structure.

11. A damper assembly comprising:
at least one cylinder;
a piston received for sliding movement within said at least one cylinder along an axis, said piston having a central hole and at least one fluid passageway spaced apart from said central hole;
a rod extending through said central hole and coupled to said piston to move said piston within said at least one cylinder;
at least one deflecting disc having a first center opening aligned with said central hole and positioned on one side of said piston to at least partially overlap said at least one fluid passageway, wherein said at least one deflecting disc has a first outer peripheral surface and a first inner peripheral surface comprising a rod contact surface;
at least one translating disc having a second center opening aligned with said central hole and positioned in an overlapping relationship with said at least one deflecting disc, said at least one translating disc having a second inner peripheral surface formed about said second center opening and a second outer peripheral surface; and
a cage having an abutment feature that constrains said at least one translating disc at said second outer peripheral surface.

12. The damper assembly according to claim 11 wherein said cage includes a base portion with a center aperture aligned with said central hole of said piston and said center openings of said at least one deflecting disc and said at least one translating disc, and wherein said cage includes a wall portion that transitions from said base portion and extends toward said piston to form said abutment feature.

13. The damper assembly according to claim 12 wherein said wall portion includes gaps and provides an outer surface to face the at least one cylinder and an inner surface that forms said abutment feature.

14. The damper assembly according to claim 13 wherein said base portion comprises a center disc-shaped portion including said center aperture and a plurality of radially extending extension surfaces that are circumferentially spaced apart from each other about said center aperture by gaps with each radially extending extension surface transitioning into said wall portion.

15. The damper assembly according to claim 11 including a backing member positioned axially between said cage and said one side of said piston.

16. The damper assembly according to claim 15 wherein said cage radially constrains said at least one translating disc by direct abutment against said second outer peripheral surface and wherein said backing washer compresses said at least one deflecting disc in cooperating with said cage to provide a desired preload.

17. The damper assembly according to claim 11 wherein said at least one deflecting disc comprises a plurality of deflecting discs and wherein said at least on translating disc comprises a plurality of translating discs, and wherein the plurality of translating discs are sandwiched between said one side of said piston and a majority of said plurality of deflecting discs.
